(19) United States
(12) Patent Application Publication
(10) Pub. No.: US 2025/0086604 A1
(43) Pub. Date: Mar. 13, 2025

(54) SYSTEMS AND METHODS FOR TRADING MEMBERSHIPS

(71) Applicant: The PNC Financial Services Group, Inc., Pittsburgh, PA (US)

(72) Inventors: Dennis Michael Degnan, Jr., Pittsburgh, PA (US); Brianna Katherine Hogan, Coraopolis, PA (US); Vorachat Tamarree, Pittsburgh, PA (US); Douglas Carlton Kobin, Pittsburgh, PA (US); Deirdre Mary Gannon, Shaker Heights, OH (US); Max Ellsworth Goldstein Jahnke, Pittsburgh, PA (US); Lindsey Marie Boyko, Pittsburgh, PA (US); Lu Chen, Pittsburgh, PA (US)

(73) Assignee: The PNC Financial Services Group, Inc., Pittsburgh, PA (US)

(21) Appl. No.: 18/956,103

(22) Filed: Nov. 22, 2024

Related U.S. Application Data
(63) Continuation of application No. 18/626,841, filed on Apr. 4, 2024.
(60) Provisional application No. 63/510,478, filed on Jun. 27, 2023.
(60) Provisional application No. 63/607,745, filed on Dec. 8, 2023.

(51) Int. Cl. G06Q 20/12; G06Q 30/0201

(52) U.S. Cl. CPC G06Q 20/123; G06Q 30/0206; G06Q 2220/00

(57) ABSTRACT

Disclosed embodiments relate to systems and methods for managing user memberships over a distributed computing network on a server. Techniques include authenticating a membership issuer, generating a cryptographic digital asset associated with a membership, creating a software module, associating the cryptographic digital asset with a first user, receiving a request to transfer the cryptographical user from the first user to a second user, transferring the cryptographic digital asset, and updating an agreement based on the transfer.

### CROSS REFERENCE TO RELATED APPLICATIONS

This application claims the benefit of priority of U.S. Provisional Patent Application No. 63/510,478 filed on Jun. 27, 2023, and U.S. Provisional Patent Application No. 63/607,745 filed on Dec. 8, 2023, the contents of which are incorporated herein by reference in their entirety.

### TECHNICAL FIELD

The present disclosure relates generally to systems and methods for management of user memberships over a distributed computing network on a server using cryptographic digital assets.

### BACKGROUND INFORMATION

Traditional methods of registering memberships associated with a membership issuer may involve a user registering membership credentials and then logging in using their credentials to associate a particular user with a particular membership. The membership associated with a user may only be associated with that user, with limited ability for a user to sell or trade a membership if it is no longer needed.

Various options exist for people to sell memberships associated with a membership issuer over the Internet. For example, some companies permit users to sell back their memberships to the company for a price, such as airlines allowing customers to sell their miles. In another example, users may transfer their memberships to another member. For example, airlines allow customers to transfer miles to other customers. These traditional systems have a number of problems, including that they are not efficient because they are unable to process transactions securely and efficiently. For example, a user may need to find someone who wants the membership and may face issues with vetting an interested buyer and the transfer of the membership could take several days, which leads to slow transactions. Users may also face issues with vetting other users on both ends of a transaction. For example, a user interested in transferring may not know if the interested user has the capital to complete a transfer. On the other side, the interested user may not know the history of the membership or if the user even has the proper permissions to transfer the membership. This may lead to a lack of transparency with respect to the history of a membership. There could be fake or black-market memberships being traded. There may also be a need for several different participants in the transaction. For example, there might be a need for an organization to vet membership issuers, membership buyers, and membership sellers, which may be different from the platform listing the offerings, and banks that settle and clear transactions.

Therefore, there is a need for a comprehensive system for managing user memberships in which transactions are processed efficiently and traded in a trustworthy manner. The system may create, trade, engage, collateralize, and monitor user memberships using a distributed blockchain ledger. Blockchain technology, because its central asset is a distributed technology, is decentralized and thus resistant to data tampering and allows for information traceability. This can enhance the reliability of tracking and recording the trading of memberships between users. By having a membership issuer opt in to using blockchain technology, the trading process becomes independent of the membership issuer and allows for trading without the traditional issues of security and mistrust, while protecting users' personal privacy. In addition, the storage and management of memberships across different membership issuers may present challenges with respect to different organizational rules and requirements. For example, an airline may have different rules with respect to its frequent flyer miles than a grocery store with a membership rewards program for its customers. The present solution aims to tackle these challenges, which are not present in traditional blockchain transactions, which may involve just cryptocurrency, and only require the use of the same cryptocurrency. Organizations also may have concerns about personal data and the privacy of its customers. Thus, implementation of a system to manage user memberships must also require steps that protect user data and manage privacy concerns. The use of a blockchain within the system ensures that membership history is properly tracked to ensure proper membership ownership and that the owners of the membership are the actual owners, and not the result of a hack or an illegitimate transfer. The use of blockchain also protects user privacy, while enhancing accuracy, transparency, and security of managing the transfer and use of memberships.

### SUMMARY

The disclosed embodiments describe non-transitory computer readable media, systems, and methods for management of user memberships. For example, the method may include authenticating a membership issuer using a graphical user interface. The method may further include issuing a membership to a first user, over a distributed computing network on a server. The membership may be issued to a user device associated with the first user. The method may also include generating a cryptographic digital asset associated with the membership using an application programming interface (API) call; creating, using the distributed computing network, a software module comprising an agreement and one or more predetermined conditions, wherein the software module is programmed to automatically update ownership of the cryptographic digital asset upon completion of the one or more predetermined conditions; associating the cryptographic digital asset with the first user; transmitting, using a distributed cryptographic digital asset private key generator, the associated cryptographic digital asset to the software module; receiving a request to transfer the cryptographic digital asset from the first user to a second user; transferring, based on the received request, over the distributed computing network, the cryptographic digital asset from the first user to a second user; updating, using the distributed cryptographic digital asset private key generator, the agreement based on the association of the cryptographic digital asset with the second user; and sending for display to a user device associated with the second user, confirmation of the updated agreement.

According to some embodiments, the membership may comprise metadata.

According to some embodiments, the method may further comprise determining a value associated with the transfer of the cryptographic digital asset from the first user to the second user.

According to some embodiments, the method may further comprise transmitting a notification to the second user with instructions for accessing the cryptographic digital asset.

According to some embodiments, the cryptographic digital asset may be a non-fungible token (NFT).

According to a disclosed embodiment, the NFT may be minted with predetermined conditions.

According to some embodiments, the predetermined conditions may comprise at least one of metadata of the NFT, image data, trait data, or ownership data.

According to some embodiments, the membership may be linked to a storage unit on the distributed cryptographic digital asset private key generator.

According to some embodiments, the software module may authenticate ownership of the membership.

According to some embodiments, a membership issuer may track membership ownerships on the distributed cryptographic digital asset private key generator.

According to some embodiments, the operations may further comprise searching, on the distributed cryptographic digital asset private key generator for agreements associated with a storage unit.

According to some embodiments, the operations may further comprise displaying the agreement associated with the searched storage unit, or upon determining no agreements are associated with the searched storage unit, displaying an option to deploy a new agreement.

According to some embodiments, the software module may contain information comprising at least one value associated with the cryptographic digital asset, an image associated with the cryptographic digital asset, and a unique identifier.

According to some embodiments, the at least one value may be transferred to a storage unit associated with the first user.

According to some embodiments, the at least one value may not be transferred to a storage unit associated with the first user if the transfer is rejected.

According to some embodiments, the displaying to the user device associated with the second user may further comprise a user interface, wherein a user selects one of: closing a confirmation of the updated agreement; submitting another request; or clicking an interactive button.

According to some embodiments, the user device associated with the first user may comprise one of a mobile device, tablet, or a personal computer.

According to some embodiments, the user device associated with the second user may comprise one of a mobile device, tablet, or a personal computer.

According to some embodiments, the operations may further comprise marking the cryptographic digital asset, through the software module with an attribute.

Throughout, this disclosure the phrase “disclosed embodiments,” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an exemplary problem for managing user memberships, consistent with disclosed embodiments.

FIG. 2 illustrates an exemplary solution for managing user memberships, consistent with disclosed embodiments.

FIG. 3 illustrates an example system environment for managing user memberships, consistent with the disclosed embodiments.

FIG. 4 is a block diagram showing an example server, consistent with the disclosed embodiments.

FIG. 5 illustrates an example cryptographic digital asset generation and storage process.

FIG. 6 illustrates an example membership management process, consistent with the disclosed embodiments.

FIG. 7 is a flowchart illustrating an example process for managing user memberships, consistent with the disclosed embodiments.

FIG. 8 illustrates an example environment for using blockchain technology to transfer and manage user memberships, consistent with the disclosed embodiments.

FIG. 9 illustrates an example embodiment of a public blockchain that stores all information related to the management of user memberships, consistent with disclosed embodiments.

FIG. 10 illustrates an example embodiment of a public blockchain that stores some information related to the management of user memberships but not all information, consistent with disclosed embodiments.

FIG. 11 illustrates an example embodiment of a private blockchain that stores all information related to the management of user memberships, consistent with disclosed embodiments.

FIG. 12 illustrates an example embodiment of a private blockchain that stores some information related to the management of user memberships but not all information, consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

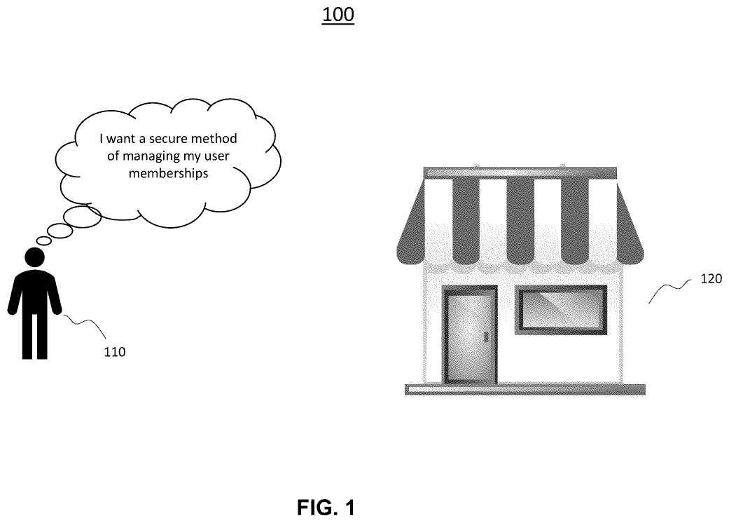

FIG. 1 illustrates an exemplary problem 100 for managing user memberships, consistent with disclosed embodiments. An exemplary user 110 is shown, with a thought bubble that user 110 wants a secure method to manage user memberships. An exemplary membership issuer 120 is also shown. There is no way of connecting membership issuer 120 with user 110 to securely manage memberships.

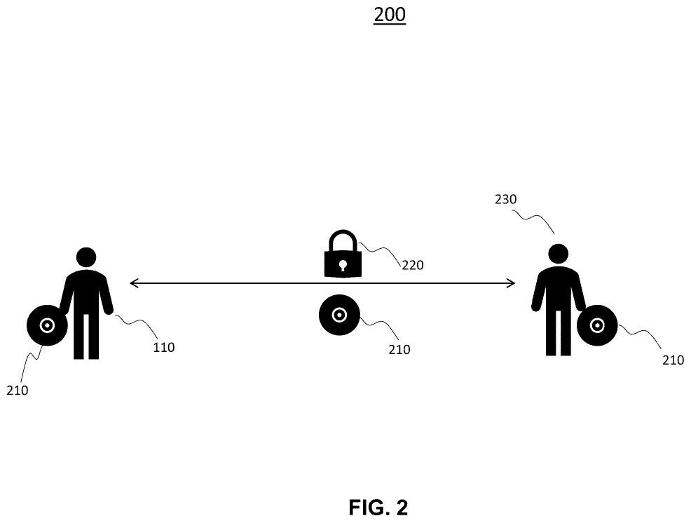

FIG. 2 illustrates an exemplary solution 200 for managing user memberships, consistent with disclosed embodiments. FIG. 2 illustrates an exemplary first user 110, and an exemplary second user 230, along with a cryptographic digital asset 210, which may be securely managed using solution 200 and secure method 220. As shown in FIG. 2, cryptographic digital asset 210 may be transferred from first user 110 to second user 230.

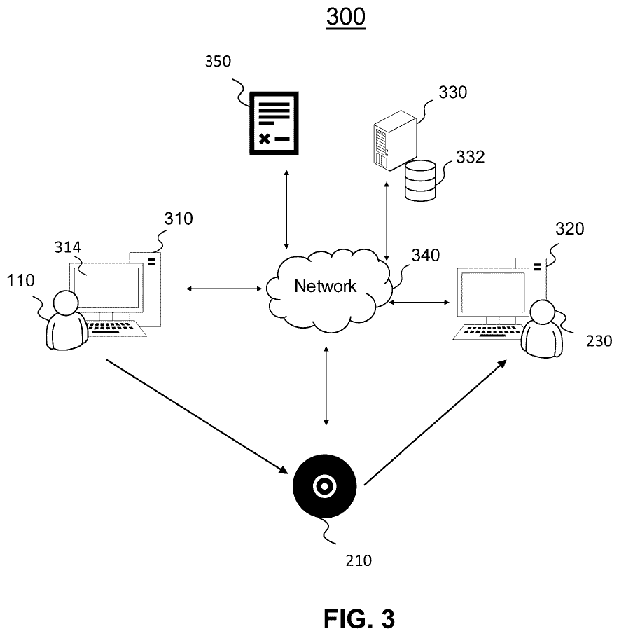

FIG. 3 illustrates an example system environment 300 for securely managing user membership, consistent with the disclosed embodiments. A membership may refer to the state of belonging to an organization. In some embodiments, a membership may be associated with a physical or digital membership card or other token indicating membership. In some embodiments, a membership may be associated with a fee. For example, a membership may refer to a gym membership or to being a participating member of a membership program with an organization, such as an airline frequent flyer program, or a grocery store frequent shopper program. System environment 300 may include one or more first user devices 310, associated with first user 110, one or more second user endpoint devices 320, associated with second user 230, one or more graphical user interfaces 314, one or more servers 330, network 340, one or more databases 332, one or more as shown smart contract 350, and one or more cryptographic digital assets 210, as shown in FIG. 3. System environment 300 may represent a system or network environment in which activities of a first user 110 and a second user 230 on user devices 310 and 320, respectively are recorded and stored on server 330, and associated with smart contract 350.

The various components of system 300 may communicate over a distributed computing network 340. Network 340 may be configured to receive a request for a new cryptographic digital asset, consistent with disclosed embodiments. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 300 is shown as a network-based environment, it is understood that in some embodiments, one or more aspects of the disclosed systems and methods may also be used in a localized system, with one or more of the components communicating directly with each other. In some embodiments, activities of a user may comprise making transactions associated with a user membership. In some embodiments, a user may trade, sell, or buy one or more memberships. The recording, transmission, and storage of the recorded user activity may be performed in a secure manner, such that only network 340 and the components which are connected to network 340, which may be part of a distributed ledger, has access to the information. In some embodiments, a distributed ledger is a digital system for recording the transaction of assets in which the transactions are recorded in multiple places at the same time. In some embodiments, a distributed ledger does not have a central data store.

First user device 310 and second user device 320 may include any form of computer-based device or entity through which first user 310 and second user 230, respectively, may access a graphical user interface 314 to manage user memberships. For example, first user device 310 and/or second user device 320 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may be capable of accessing web pages or other network locations. In some embodiments, user endpoint device 320 may be a virtual machine (e.g., based on AWS™, Azure™, IBM Cloud™, etc.), container instance (e.g., Docker™ container, Java™ container, Windows Server™ container, etc.), or other virtualized instance. First user device 310 and second user device 320 may be configured such that user 110 and user 230 may access network 340 through a browser or other software executing on first user device 310 and second user device 320.

In some embodiments, first user 110 differs from second user 230. In other embodiments, first user 110 may be the same as second user 230. In some embodiments, a user may represent an individual. In other embodiments, a user may represent an organization or entity.

First user device 310 and second user device 320 may communicate with server 330 through network 340. Server 330 may include any form of remote computing device configured to receive, store, and transmit data. For example, server 330 may be a server configured to store files accessible through a network (e.g., a web server, application server, virtualized server, etc.). Server 330 may be implemented as a Software as a Service (SaaS) platform through which software for auditing recorded user activity may be provided to an organization as a web-based service.

In some embodiments, database 332 may be coupled to a server, such as server 330. Database 332 may be included on a volatile or non-volatile, magnetic, semiconductor, tape, optical, removable, non-removable, or other type of storage device or tangible or non-transitory computer-readable medium. Database 332 may also be part of server 330 or separate from server 330. When database 332 is not part of server 330, server 330 may exchange data with database 332 via a communication link. Database 332 may include one or more memory devices that store data and instructions used to perform one or more functions of the disclosed embodiments. Database 332 may include any suitable databases, ranging from small databases hosted on a work station to large databases distributed among data centers. Database 332 may also include any combination of one or more databases controlled by memory controller devices (e.g., server(s), etc.) or software. For example, database 332 may include document management systems, Microsoft SQL™ databases, SharePoint™ databases, Oracle™ databases, Sybase™ databases, other relational databases, or non-relational databases, such as mongo and others. In some embodiments, server 330 may include one or more input/output devices, communications devices, displays, and/or other interfaces (e.g., server-to-server, database to-to-database, or other network connections).

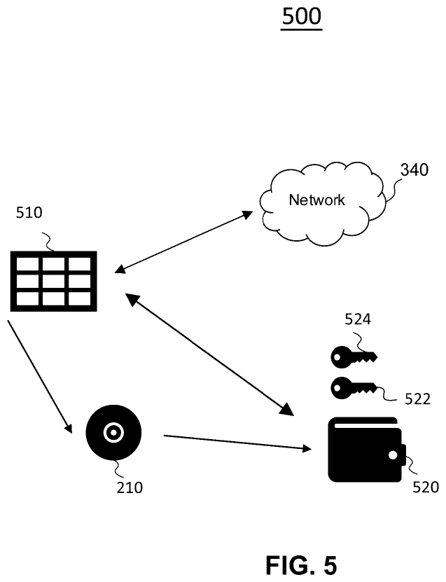

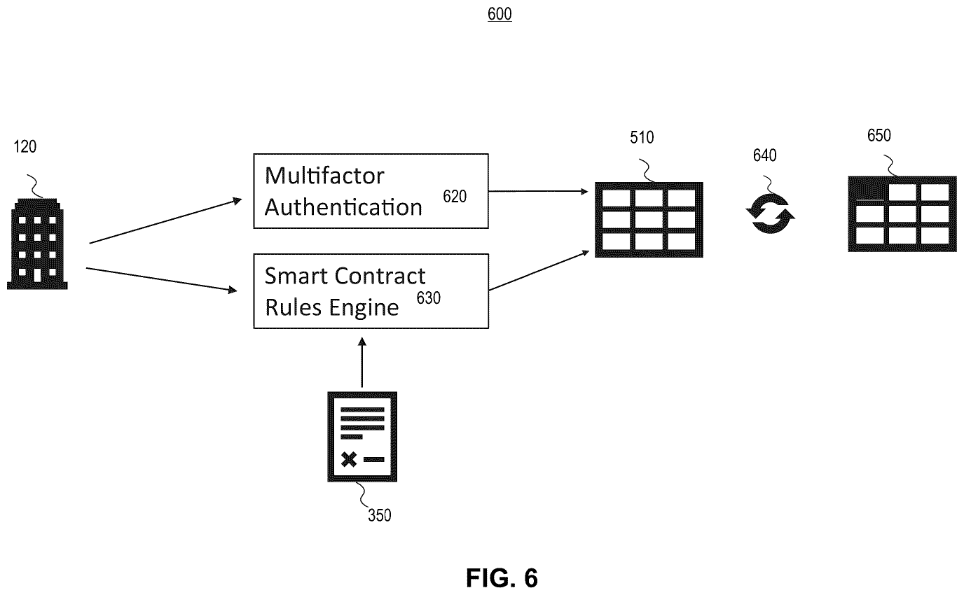

Distributed computing network 340 may be used to create a smart contract 350. In some embodiments, smart contract 350 may be a software module comprising an agreement and one or more predetermined conditions. In some embodiments, smart contract 350 may enable users to transfer ownership of one or more memberships and onboard one or more new memberships through membership issuer 120, as described in FIG. 6. In some embodiments, onboarding new memberships may comprise issuing a new membership to a user. In some embodiments, smart contract 350 may utilize a blockchain ledger to verify, execute, and enforce the terms of an agreement related to smart contract 350, as described in further detail in FIG. 5. Smart contract 350 may be embedded with predetermined conditions to ensure compliance with membership regulations. In some embodiments, membership regulations may refer to a set of rules, requirements, qualifications, and regulations associated with a membership issuer. A membership issuer may define their membership regulations using the smart contract 350. In some embodiments, the predetermined conditions may be embedded into lines of code of the software module (e.g., smart contract 350) that are executed. For example, a membership issuer 120, as described in FIG. 6, may have conditions associated with the membership that are transferred with the ownership and embedded on smart contract 350. Smart contract 150 may be associated with each individual transaction between, for example, a first user and a second user, such as first user 110 and second user 230. First user 110 and second user 230 may supply information to verify the users are eligible to conduct a transaction. The information supplied may verify that first user 110 has supplied information to confirm that first user 110 has permissions to transfer a membership to second user 230. For example, the permissions may include verify first user 110 is the owner of the membership. Before the membership is transferred, a buyer looking to purchase the membership may place the payment for the membership into the smart contract 350 by attaching a payment for a transaction to the smart contract 350. In some embodiments, the smart contract 350 may only act on data stored in the blockchain and is based on data attributes stored in the blockchain. Verification of the information may involve confirming that the potential buyer has the required funds to conduct the transaction. A buyer that does not have the required funds may not be able to conduct the transaction. A buyer with the required funds that does not transfer them to the smart contract 350 may not be able to reserve a membership to purchase. For example, the verification process may involve confirming a potential buyer has the proper capital (e.g., sufficient monetary value) to purchase a membership, and confirm that a potential seller owns the membership and can sell it. In some embodiments, the users may provide the information directly. In other embodiments, a blockchain ledger, such as blockchain ledger 510 may be used in verification. In some embodiments, smart contract 350 is embedded with predetermined conditions that must be met before a membership transfer can occur. In some embodiments, membership issuer 120 determines the predetermined conditions. In some embodiments, first user 110 and second user 230 may agree upon transfer terms and upload those terms to smart contract 350. For example, transfer terms may include a membership price, a date of transfer, and a payment method. In some embodiments, once the predetermined conditions and the transfer terms are met, the membership may automatically transfer from a seller, such as user 110, to a buyer, such as user 230 on the distributed ledger. The transfer may be triggered after the parties are verified and the transaction is initiated. Once the predetermined conditions of the smart contract are met, network 340 may initiate the transfer.

Smart contract 350 may be linked to a contract template for a user. In some embodiments, a smart contract template may be pre-written code snippets that are customizable for different use cases. Smart contract templates may be used to crate standardized language to use across different smart contracts. Smart contract templates may be used to save time, avoid mistakes, and follow best practices that may be established by a membership issuer. Smart contract templates may increase efficiencies by avoiding rewriting language that may be used across all smart contracts for a particular user or organization. Smart contract 350 may refer to a computerized transaction protocol that executes the terms of a contract. In some embodiments, the smart contract 350 may be a self-executing contract. A self-executing smart contract may become effective as soon as it is signed or another requirement is met, without further action being needed. In some embodiments, a smart contract may automatically execute once the document is signed or another condition is met. In some embodiments, the smart contract may be directly written into software code. In some embodiments, the software code may control the execution of the smart contract. In some embodiments, transactions that occur using smart contracts may be traceable and may not be reversible. The template may have operational parameters that identify essential requirements for a contract, no matter who the user is. As a non-limiting example, the contract may require a username, an associated email address or contact information, a first party blockchain address, a second party blockchain address, and a payment method. The smart contract may also contain any essential content of the contract, as determined by the user. In some embodiments, system 300 may retrieve an appropriate contract template based on the information the user provides for the smart contract. In some embodiments, the contract template may be displayed to a user on an interface, such as interface 314. The display may contain contract attributes based on the type of smart contract, the buyer and seller, and other attributes related to the contract.

The user may interact with the interface through a forms wizard or through a single page form. In some embodiments, the smart contract may be generated based on user input to an interface, such as interface 314. The contract may be assigned a blockchain number and inserted into the blockchain. In some embodiments, once the terms of the contract are met, the smart contract may initiate payment or transfer of a membership. In some embodiments, the user selling a membership may input the required information to execute the smart contract before it is sent to a user buying a membership. The user buying a membership may be required to input verification information or details in the smart contract before the transfer of the membership can occur, as described above.

In some embodiments, the transfer of a membership occurs through a cryptographic digital asset, such as cryptographic digital asset 210 using key generators, as shown and described in FIG. 5. In some embodiments, cryptographic digital asset 210 may be a non-fungible token (NFT) that represents ownership of a unique digital item, such as a membership. In some embodiments, the NFT may be connected to a real-world product. In some embodiments, the NFT may be a computer-generated representation of the real-world product, such as a membership. Using the digital asset, the owner of the digital asset may be able to trade or sell the membership associated with the NFT.

In some embodiments, cryptographic digital asset 210 may be a computer-generated virtual object with a unique, non-fungible tokenized code registered on and validated by a blockchain platform. In some embodiments, ownership of the digital asset does not grant intellectual property rights to the digital asset the token represents. For example, if the digital asset represents a brand loyalty card, the trademark associated with a logo on the card would still belong to a membership issuer, and not with the owner of the digital asset. The digital asset may represent proof of ownership separate from intellectual property, such as the rewards associated with a brand loyalty card. In some embodiments, cryptographic digital asset 210 may only have one owner. In other embodiments, cryptographic digital asset 210 may have more than one owner.

In some embodiments, ownership of an NFT certifies that the holder owns the NFT and can sell, trade, or redeem it. In some embodiments, cryptographic digital asset 210 may be stored and recorded on the blockchain ledger, such as blockchain ledger 510, as described in FIG. 5. The NFT may exist in perpetuity or may exist for the lifetime of a blockchain network. In some embodiments, a membership issuer may determine a lifetime for the NFT. In some embodiments, the NFT may be a one of a kind asset that is managed in a digital ledger, such as blockchain ledger 510. The NFT may be attached to a distinct value with a certificate of authenticity. In some embodiments, even if the NFT exists only online, it cannot be easily duplicated because of the certificate of authenticity. The lack of fungibility associated with an NFT distinguishes it from fungible products, such as cryptocurrency, which are interchangeable, and thus not fungible. A buyer of an NFT with ownership of the asset can resell the asset.

Cryptographic digital asset 210 may be embedded with information about the membership with which it is associated. For example, the information may include a membership issuer identification number to uniquely associate the cryptographical digital asset 210 with the membership issuer 120, the first user 110 as the current owner, and any other specified data. The embedded information may also include predetermined conditions and transaction history data. In some embodiments, the cryptographic digital asset 210 is an NFT that has been customized using images, audio, video, or the like. In some embodiments, the cryptographic digital asset may be compatible with NFT digital exchanges. Different actions may be associated with cryptographic digital asset 210, such as customization of the asset, selling of the asset, buying of the asset, trading of the asset, and licensing of the asset. In some embodiments, cryptographic digital asset 210 may be associated with a value based on the value of the product or service associated with the cryptographic digital asset. In some embodiments, this embedded information may also be stored on blockchain ledger 510.

The process of transferring cryptographic digital assets 210 between different users ensures that no asset can be lost or duplicated. Once an asset is transferred, it is no longer available unless the new owner places it for sale. Each transaction is verifiable by any party reviewing the blockchain transactions to verify the ownership of the asset.

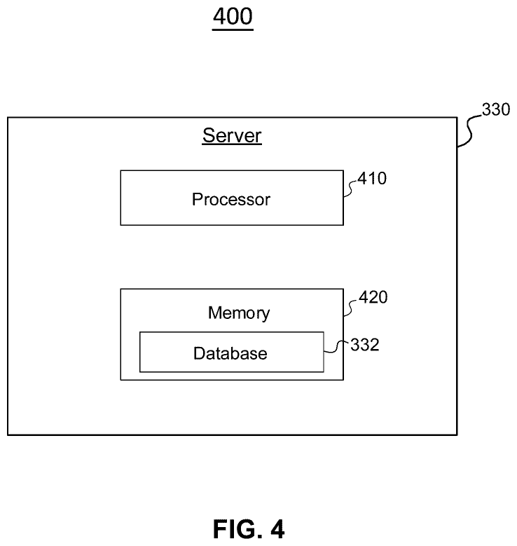

FIG. 3 is a block diagram showing an example server 330, consistent with the disclosed embodiments. As described above, server 330 may be a computing device (e.g., a server, etc.) and may include one or more dedicated processors and/or memories. For example, server 330 may include a processor (or multiple processors) 410, and a memory (or multiple memories) 420, as shown in FIG. 4.

Processor 410 may include any physical device or group of devices having circuitry configured to perform one or more logic operations on an input or inputs. For example, processor 410 may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. Processor 410 may take the form of, but is not limited to, a microprocessor, embedded processor, or the like, or may be integrated in a system on a chip (SoC). Furthermore, according to some embodiments, processor 410 may include one or more of the family of processors manufactured by Intel®, AMD®, Qualcomm®, Apple®, NVIDIA®, or the like. The processor 410 may also be based on the ARM architecture, a mobile processor, or a graphics processing unit, etc. The disclosed embodiments are not limited to any type of processor configured in server 330.

Memory 420 may include one or more storage devices configured to store instructions used by the processor 410 to perform functions related to server 330. The disclosed embodiments are not limited to particular software programs or devices configured to perform dedicated tasks. For example, the memory 420 may store a single program, such as a user-level application, that performs the functions associated with the disclosed embodiments, or may comprise multiple software programs. Additionally, the processor 410 may, in some embodiments, execute one or more programs (or portions thereof) remotely located from server 330. Furthermore, memory 420 may include one or more storage devices configured to store data for use by the programs. Memory 420 may include, but is not limited to a Random Access Memory (RAM), a Read-Only Memory (ROM), a hard drive, a solid state drive, an optical disk, other permanent, fixed, or volatile memory, a CD-ROM drive, a peripheral storage device (e.g., an external hard drive, a USB drive, etc.), a network drive, a cloud storage device, or any other mechanism capable of storing instructions. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively, and may be co-located or located remotely from each other. The processors may be coupled electrically, magnetically, optically, or by any other way that permits them to interact with each other.

In some embodiments, memory 420 may include a database 332 as described above.

FIG. 5 illustrates an example cryptographic digital asset generation and storage process 500. In some embodiments, process 500 may be facilitated by distributed computing network 340. In some embodiments, network 340 may communicate with a blockchain ledger, such as blockchain ledger 510, which is linked to a cryptographic digital asset 210. In some embodiments, blockchain ledger 510 is associated with public key 522 and private key 524, which may be stored in a wallet 520.

In some embodiments, a public key may be used to send and receive a transaction on a blockchain. The blockchain may include at least one cryptographic digital asset 210 registered on it. In some embodiments, the blockchain may be in communication with a platform for trading memberships, as described with respect to FIG. 6. In some embodiments, a public key may be publicly known and is published and is used for identification purposes to authenticate a user when matched with the private key. In some embodiments, the public key may be publicly accessible to nodes on distributed computing network 340 and may be used to encrypt data on blockchain ledger 510. In some embodiments, a node may refer to a communication endpoint on a network, such as network 340. In some embodiments, a private key may be used to verify transactions and prove ownership, such as ownership of a membership. In some embodiments, a private key may only be used for the owner of a wallet, such as wallet 520. In some embodiments, wallet 520 may be a cryptocurrency wallet that allows a user to manage different kinds of cryptocurrencies. In some embodiments, wallet 520 may be a data structure or other structure used to store data. In some embodiments, wallet 520 may be a financial transaction application that securely stores information. In some embodiments, wallet 520 may store blockchain information for users on distributed computing network 340. In some embodiments, wallet 520 stores pertinent information for an individual user to make transactions using blockchain. For example, wallet 520 may store membership information, private key information, and transaction history related to the wallet. In some embodiments, wallet 520 may store public key 522 and private key 524.

The public key and private key may be associated with wallet 520. A private key can be thought of as a password to the wallet and should be kept secret. Just as if someone finds a password and may have access to private information, if someone that is not the owner has the private key, they can access all information in the wallet. In some embodiments, a private key may be a numerical code. In some embodiments, a private key may be used as confirmation of the identity of a user based on a ground source of truth, such as the blockchain ledger, financial institution, merchant, government, or other entity that keeps records and records identities.

In some embodiments, a private key is generated first and a corresponding public key is derived using a known algorithm. In some embodiments, the private key may be stored on a wallet, such as wallet 520. In some embodiments, it is not possible to derive the private key from the public key. By using the stored keys in the wallet, the owner of a digital asset may sign a transaction to trade or sell the digital asset and write the transaction to the blockchain ledger. Signing a transaction may refer to the process of verifying the digital transaction. In some embodiments, private key 524 may be used by wallet 520 to decrypt encrypted text and reveal the text. In some embodiments, the owner of the private key may use the private key to determine which transactions are associated with their wallet 520. In some embodiments, wallet 520 may be referenced as a storage unit. In some embodiments, the private key may be a secret, randomly generated string of alphanumeric characters used to secure data and confirm an identity of a user. In some embodiments, computer nodes may maintain the blockchain and validate each new block on the blockchain. In some embodiments, this validation process may involve solving a computational problem. In some embodiments, system 300 may contain computer nodes that are used to validate transactions on the blockchain. In some embodiments, once a node adds a transaction to the blockchain, other nodes in the system may receive copies of the transaction to store. In some embodiments, a distributed computing network has multiple nodes that work together to solve a common problem.

In some embodiments, once a membership transfer is approved, a new entry is created on blockchain ledger 510.

In some embodiments, each time a user wishes to buy, sell, or trade a membership, wallet 520 may be used to provide access to distributed computing network 340, where blockchain ledger 510 is stored. Wallet 520 may be implemented in software. Wallet 520 may be implemented in hardware. Wallet 520 may be used to store virtual currencies. Wallet 520 may also be used to create, store, transfer, and manage cryptographic digital assets, such as cryptographic digital asset 210. Wallet 520 may also communicate with smart contract 350 to enable users to transfer and manage memberships. In some embodiments, wallet 520 may be used to sign transactions to smart contract 350. In some embodiments, any interaction with smart contract 350 uses wallet 520 to sign the transactions cryptographically. For example, interactions may include transferring ownership of a membership, redeeming rewards points, upgrading a membership tier, and so on. This communication may be facilitated through network 340 using a processor, such as processor 410.

In some embodiments, a user may use their wallet 520 to submit bids for a membership or purchase memberships made available through distributed computing network 340. In some embodiments, a bid is an offer to set a price tag for a membership. Bids may be used to determine the cost or value of a membership. In some embodiments, a bid may be submitted using a wallet, such as wallet 520. A membership issuer 120 may track a transaction through interface 314 using the history associated with wallet 520. Tracking a transaction may involve viewing the history of a transaction, such as the date of the transaction, a value associated with the transaction, and the owner of the membership associated with the transaction. In some embodiments, a membership issuer 120 may implement an independent monitoring system to call the blockchain to retrieve information related to a transfer. In some embodiments, notifications or alerts related to bids and transfers may be sent using the email address associated with a user.

After a successful membership transfer, wallet 520 may add an entry to blockchain ledger 510 to reflect the completion of the transfer and change the membership ownership from a first user 110 to a second user 230. In response, cryptographic digital asset 210 may be transferred from a wallet associated with first user 110 to a wallet associated second user 230 with the terms of the smart contract 350.

In some embodiments, blockchain ledger 510 may store and record cryptographic digital asset 210. Blockchain ledger 510 may be used to list and create memberships, transfer membership ownership, and allow certain permissions for certain users. In some embodiments, when a new transaction is created, the membership associated with the transaction may be stored on blockchain ledger 510, along with its represented entry in blockchain ledger 510. Blockchain ledger 510 may record the unique cryptographic digital asset identifier and receive verification that the new transaction block has been recorded through a confirmation. A confirmation represents the acceptance of a new block to the blockchain. Confirmations help to maintain the security and integrity of the blockchain. A transaction block is a collection of transactions that are validated and added to the blockchain, while a transaction represents a transfer between two parties. In some embodiments, a transaction may be associated with a bid for a membership to buy, transfer, or sell a membership. In some embodiments, transfer of a membership ownership must occur within the same network the cryptographic digital asset is stored on. A user may submit a bid to initiate a transaction. In some embodiments, all transactions may be performed using a smart contract and may be tracked on a blockchain ledger. A blockchain may store transaction data in blocks linked together that form a chain. As the number of transactions increases, so does the blockchain, with individual blocks that represent individual transactions being added to the blockchain. Each block may record and confirm the time and the sequence of transactions, which are then logged onto the blockchain. In some embodiments, each block contains a hash, which is timestamped. The previous block hash links the blocks together, preventing any block from being altered or a block being entered in between two existing blocks. In this way, the blockchain operates as an append-only system, where the ledger only records transactions once, thus eliminating duplication. In some embodiments, a smart contract may be stored on the blockchain and executed automatically as part of a transaction.

Blockchain ledger 510 may be updated in real time to track and validate all transactions associated with cryptographic digital asset 210. In some embodiments, real time may be a guaranteed level of computer responsiveness within a specified time constraint between an event and its response deadline. Blockchain ledger 510 may also contain all previous transactions to create a transactional history. Blockchain ledger 510 may also contain a sequential history in which transactions occurred since the blockchain operates as an append-only system. Blockchain ledger 510 may be used to validate and authenticate transactions history.

Blockchain ledger 510 may be implemented using a distributed computing network 340. Blockchain ledger 510 may be implemented as an append only ledger, meaning that no erasures of data in the ledger can occur. In some embodiments, a cryptographic hashing technique may be used on the blockchain ledger. In some embodiments, the blockchain ledger may use the Ethereum network. Ethereum is a decentralized blockchain with smart contract functionality. Hash functions are essential tools in modern cryptography and blockchain technology. Hash functions may allow for users to securely store and transmit data by converting it into a fixed-length string of characters, known as a hash. On the Ethereum network, a hash function known as Keccak256 may be used. Keccak256 is a cryptographic hash function that takes an input of an arbitrary length and produces a fixed-length output of 256 bits. A hash function may also refer to a cryptographic algorithm used to produce a unique value.

Records within blockchain ledger 510 may be verified by third parties using a technique called mining. The mining techniques are the computational work that network nodes undertake to validate information contained in the blocks within the blockchain ledger. Miners are also known as auditors because they verify the legitimacy of transactions on the blockchain. The systems allow any party to review or analyze the blockchain ledger to determine the authenticity of particular transactions. However, the system protects against those without access to a private key to access information or transact within the blockchain. In some embodiments, mining may involve the use of an algorithm to confirm the blocks comprising a blockchain are valid. For example, the algorithm may confirm a previous block referenced by the new block exists and is valid. The algorithm may check to confirm a timestamp associated with the previous block occurs before that of the new block.

FIG. 6 illustrates an example membership management platform 600, consistent with the disclosed embodiments. A membership issuer 120, which may be an individual issuer or an entity issuer, may submit a request to issue a membership. As explained with respect to FIG. 3, the request may comprise a smart contract 350. The smart contract 350 may communicate with a rules engine, such as smart contract rules engine 630 to specify the terms, regulations, and restrictions that apply to a specific membership. In some embodiments, issuing a membership may require an approval by an administrator associated with membership issuer 120.

Smart contract rules engine 630 may be configured to implement any functionality associated with smart contracts, such as smart contract 350, such as transferring ownership, utilizing predetermined rules, and ensuring compliance. In some embodiments, smart contract rules engine 630 may be incorporated into cryptographic wallets, such as cryptographic wallet 520. In some embodiments, smart contract rules engine 630 may be a software system that executes one or more rules in a production environment based on legal regulation, membership issuer policy, or another source for determining rules. Smart contract rules engine 630 may be configured to determine compliance of a membership issuer with predetermined rules. Smart contract rules engine 630 may be configured to determine compliance of a buyer and seller on platform 600.

In some embodiments, elements of membership management platform 600 may be customized based on membership issuer 120. For example, membership issuer 120 may customize platform 600 to be consistent with the membership issuer's brand, logo, colors, and styles. In some embodiments, management platform 600 may be customized to only display cryptographic digital assets related to the specific membership issuer 120. In some embodiments, the cryptographic digital asset 210 may be related to a brand loyalty program associated with membership issuer 120.

In some embodiments, before a user, such as user 110 or user 230 can initiate a membership trade, there may be a multifactor authentication process to validate the user, such as multifactor authentication process 620. Multifactor authentication process 620 may comprise a username and password, a biometrics login, two factor authentication, login through a 3rd party wallet provider, or authentication using a plug in. In some embodiments, membership issuer 120 may also be authenticated using a multifactor authentication process. A user, such as user 110 or user 230 may also need to verify user information. User information may include an email address, phone number, unique user identification number, a username, and a password. This information may be required to initiate a membership trade. In some embodiments, a user may be a new user and may be required to enter all information and have it verified by platform 600 before proceeding with the transaction. In other embodiments, a user may be an existing user, and may enter certain details to confirm their identity. An existing user may be an issuer of a cryptographic digital asset, such as cryptographic digital asset 210. An existing user may be a holder or owner of an existing cryptographic digital asset. An existing user may be a buyer, looking to buy or receive an existing cryptographic digital asset.

In some embodiments, a user may be able to search for a particular digital asset using platform 600. A search may be enabled through the metadata associated with the digital asset. In some embodiments, this metadata information may provide data related to whether a digital asset is available for sale, the asking price of the digital asset, a membership level associated with the digital asset, any rewards associated with the digital asset, and any other relevant information. In some embodiments, a key value pair may be used to store the metadata information. In some embodiments, a key value pair may consist of two related data elements. The first data element may be a key that defines the dataset, and the second data element may be a variable that belongs to the dataset. For example, the key may be a color, and the value may be red.

Once a membership trade is initiated and the membership issuer has been authenticated and the membership issuer has provided the necessary information, blockchain ledger 510 may add a new data block that represents the new membership, as described previously. At step 640, the blockchain ledger may be updated to embed the membership into the blockchain ledger 650, as shown in FIG. 6. The new data block may be validated and authenticated as described with respect to FIG. 5. In some embodiments, the new data block may be linked to a cryptographic or digital wallet, such as wallet 520. Each block within a blockchain includes a cryptography hash of the previous block. In some embodiments, the link is a cryptography link between the blocks.

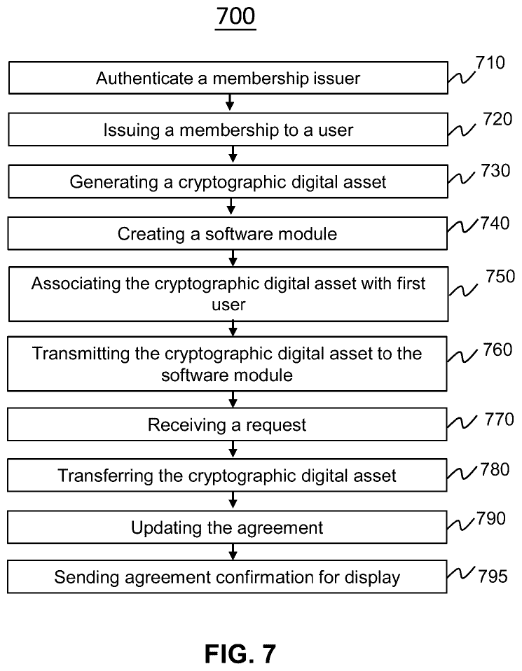

FIG. 7 is a flowchart illustrating an example process 700 for managing user memberships, consistent with the disclosed embodiments. Process 700 may be performed by at least one processing device of a server, such as processor 410, as described above. In some embodiments, process 700 may be performed by at least one user device, connected to system 300. In some embodiments, a non-transitory computer readable medium may contain instructions that when executed by a processor cause the processor to perform process 700. Further, process 700 is not necessarily limited to the steps shown in FIG. 7, and any steps or processes of the various embodiments described throughout the present disclosure may also be included in process 700, including those described above with respect to FIGS. 1-6.

In step 710, process 700 may include authenticating a membership issuer using a graphical user interface. Authentication may include a multifactor authentication process such as a username and password, a biometrics login, two factor authentication, login through a 3rd party wallet provider, or authentication using a plug in. In some embodiments, a membership issuer may comprise an entity or organization that is pre-approved. If authentication is successful, process 700 may proceed to step 720. If authentication is not successful, process 700 may not proceed to step 720. In some embodiments, if authentication is not successful, process 700 may attempt to authenticate a membership issuer again.

In step 720, process 700 may include issuing a membership to a first user, over a distributed computing network on a server, to a user device associated with the first user. The membership may be transferred from a membership issuer to an owner by replacing the entry in the blockchain ledger that associates the membership issuer's wallet information with the owner's wallet information.

In some embodiments, a membership may comprise a cryptographic digital asset, such as non-fungible token, as described in FIG. 3. In some embodiments, the cryptographic digital asset may comprise unique metadata. In some embodiments, metadata may include information about other data related to the cryptographical digital asset, including a name, an image associated with the asset, transaction data, a unique identifier, and any other information related to the cryptographic digital asset. In some embodiments, metadata may help servers process and store data more efficiently. In some embodiments, metadata may be the set of data that comprise an NFT. In some embodiments, the metadata may be in JSON format. In some embodiments, the metadata of an NFT may comprise its characteristics or properties. In some embodiments, metadata may comprise an NFT name, an NFT description, an NFT image, an NFT transaction history, an NFT trait, or any other relevant information.

In some embodiments, a distributed computing network may comprise equal, interconnected nodes to equally share data ownership and computational resources across the network. In some embodiments, nodes are equal when they have the same defining characteristics, such as number of children, attributes, and specific data points associated with the node. In some embodiments, a child node is a node extending from another node. For example, a computer with internet access may be a child node of a node with access to the Internet. The inverse relationship may describe a parent node. For example, if Node 3 is a child of Node 1, then Node 1 is the parent of Node 3. In some embodiments, a distributed computing network may not have a central server, so data processing may be crowdsourced across a network. In some embodiments, a distributed computing network can have a node fail independently without affecting the rest of the system. In some embodiments, a distributed computing network may be more scalable due to lower latency. Scalability may refer to the ability of a network to handle a growing amount of workload. Latency may refer to a time delay between a data transfer.

In step 730, process 700 may include generating a cryptographic digital asset associated with the membership. In some embodiments, the cryptographic digital asset may be representative of the membership. In some embodiments, the generating occurs using an application programming interface (API) call. In some embodiments, a cryptographic digital asset may comprise a non-fungible token (NFT) that is tokenized using blockchain. Tokenization may be the process of converting physical or virtual assets into digital units that can be bought, sold, or traded. Each cryptographic digital asset may have unique identification codes and metadata that distinguish them from other assets, thus creating a unique membership. Thus, in step 530, the membership may be converted into a digital asset such as an NFT by tokenizing the membership using blockchain. In some embodiments, the cryptographic digital asset is associated with a monetary value for which it can be bought, sold, or traded. In some embodiments, the owner of the cryptographic digital asset determines the value during the minting of the NFT.

In some embodiments the NFT may be minted with predetermined conditions. In some embodiments, minting an NFT comprises publishing an NFT on the blockchain so that it can be bought, sold, or traded. In some embodiments, the predetermined conditions may comprise the metadata of the NFT, image data, trait data, or ownership data. In some embodiments, the process of issuing a membership may require a membership issuer to mint new memberships. In some embodiments, an NFT may be automatically minted with the issuance of a new membership. In other embodiments, a membership owner may choose to mint an NFT to associate with the membership. When minting a membership, there may be required attributes. In some embodiments, required attributes may comprise the membership's owner, which may be set by default to the membership issuer's wallet, and the membership unique ID number. In some embodiments, the membership issuer may add other optional, membership-specific attributes. These attributes may include a URL pointing to an image file, a descriptor for the membership, or rewards points associated with the membership. In some embodiments, the optional attributes may be stored off the blockchain in another place, such as a database, and the optional attributes may be associated with a specific membership using the unique ID number. Membership issuers may determine how many NFTs to mint based on their own criteria which may include: the number of customers they expect to have, at the moment that a customer signs up for a new membership, a static number chosen at the beginning to generate scarcity of a membership, and thus create exclusivity with respect to the membership, or according to an algorithm or model to regulate or stabilize the value of the membership. For example, a membership issuer may determine the value of a membership or how many memberships to issue based on predicted supply and demand using a machine learning algorithm.

An “API call,” as used herein refers broadly to any request, response, message, or exchange of data between two or more computer systems, such as between client and server, or any combination of backend, middleware, and frontend components. Example API calls include calls related to read functions, write functions, delete functions, get/fetch functions, post functions, update functions, upload functions, download functions, functions to add or remove objects, start instances, stop or terminate instances, authentication functions, custom functions, or any other function that can be reasonably performed by an API call. In step 740, process 700 may include creating, using the distributed computing network, a software module comprising an agreement and one or more predetermined conditions, wherein the software module is programmed to automatically update ownership of the cryptographic digital asset upon completion of the one or more predetermined conditions. In some embodiments, the software module may comprise a smart contract, as described with respect to FIGS. 1-6. In some embodiments, the predetermined conditions may comprise terms of an agreement including the price of a membership, terms associated with the membership that are unique to a specific membership issuer, the date of transfer, and any other predetermined conditions.

In some embodiments, the software module may contain information comprising at least one value associated with the cryptographic digital asset, an image associated with the cryptographic digital asset, or a unique identifier. In some embodiments, the at least one value may comprise a dollar amount of the asset. In other embodiments, the at least one value may comprise a royalty amount associated with the asset. In some embodiments, the at least one value bay be transferred to a storage unit associated with the first user. In some embodiments, the at least one value is not transferred to a storage unit associated with the first user if the transfer is rejected. In some embodiments, the software module may mark the cryptographic digital asset with an attribute. In some embodiments, marking may comprise embedding the attribute into the software module. Embedding an attribute may mean software that is not directly visible to a human user but is part of a system and may be used to control the functionality of the software module. In some embodiments, the attribute may indicate whether the asset is for sale. An attribute may refer to a characteristic of the software module.

In step 750, process 700 may include associating the cryptographic digital asset with the first user. In some embodiments, associating the cryptographic digital asset with the first user comprises updating a blockchain ledger to reflect that the first user is the owner of the cryptographic digital asset.

In step 760, process 700 may include transmitting, using a distributed cryptographic digital asset private key generator, the associated cryptographic digital asset to the software module. In some embodiments, a private key is an alphanumeric code that acts similarly to a password to authorize a cryptocurrency transaction. In some embodiments, the private key is used to authorize a transaction. In some embodiments, the cryptographic digital asset private key generator may refer to a blockchain ledger. In some embodiments, a private key is generated using a storage unit, as described with respect to FIG. 5. In some embodiments, the storage unit may comprise a digital wallet associated with the distributed cryptographical digital asset. In some embodiments, the private key may be generated using encryption.

In step 770, process 700 may include receiving a request to transfer the cryptographic digital asset from the first user to a second user. The request may be initiated by the first user or the second user. In some embodiments, the request may be a request to trade digital assets. In other embodiments, the request may be a request to buy or sell the digital asset.

In step 780, process 700 may include transferring, based on the received request, over the distributed computing network, the cryptographic digital asset from the first user to a second user. In some embodiments, the transfer may be contingent on the predetermined rules in the smart contract, as described in step 740. In some embodiments, transferring the digital asset may further comprise transmitting a notification to the second user to a user device associated with the second user. In some embodiments, the notification may comprise instructions for accessing the cryptographic digital asset based on information associated with the software module. Transferring the cryptographic digital asset may comprise transferring ownership of the asset from the first user to the second user.

In some embodiments, a membership issuer may search for a particular transaction. In some embodiments, the search may be for a particular type of membership, a particular user, or a particular cryptographic digital asset. In some embodiments, before transferring the cryptographic digital asset, process 700 may further comprise displaying the transaction associated with the searched storage unit or wallet. In some embodiments, the search may comprise searching for an agreement associated with the cryptographic digital asset. For example, if an existing agreement already exists with respect to the cryptographic digital asset that does not allow transfer of ownership, then the transfer may not be allowed. Upon determining an existing agreement, process 700 may not allow the transfer to continue and may return an error. Upon determining no agreements are associated with the searched storage unit or cryptographic digital asset, step 780 may proceed with the transfer.

In step 790, process 700 may include updating, using the distributed cryptographic digital asset private key generator, the agreement based on the association of the cryptographic digital asset with the second user. In some embodiments, updating may comprise updating the blockchain ledger, as described in FIG. 6. In some embodiments, based on the transaction history of the blockchain ledger, a membership issuer may track membership ownerships on the distributed cryptographic digital asset. In some embodiments, a membership issuer may search on the blockchain ledger for a cryptographic digital asset associated with a particular storage unit or wallet.

In step 795, process 700 may include sending for display to a user device associated with the second user, confirmation of the updated agreement. In some embodiments, confirmation of the updated agreement may comprise confirmation that the cryptographic digital asset was transferred from a first user to a second user or be representative of a successful sale of the asset. In some embodiments, the confirmation may appear as a pop-up window on the display. In some embodiments, the display further comprises an interface for the second user to close a confirmation of the updated agreement, submit another request, or select an interactive button.

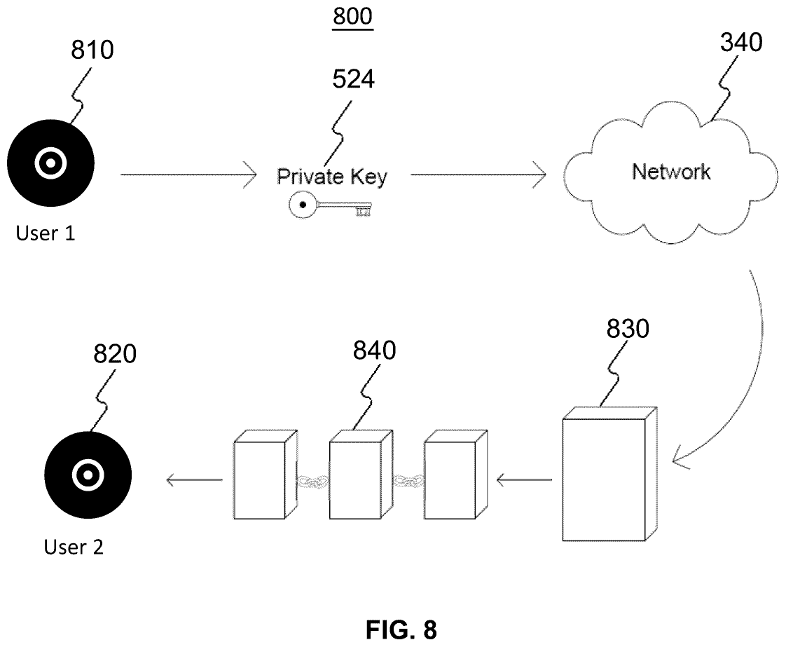

FIG. 8 illustrates an example environment 800 for using blockchain technology to transfer and manage user memberships, consistent with the disclosed embodiments. FIG. 8 shows the transfer of a cryptographic digital asset from user 1 810 to user 2 820 using cryptographic proof between the two users to execute a transaction. As illustrated in FIG. 8, a private key 524 is used to gain access to the blockchain and perform a secure transaction on network 340 that validates transactions on the blockchain. The transaction may be when one person transfers a digital asset to another person. Once the validity of the transaction is confirmed using a cryptographic hashing technique, a new block of the blockchain ledger is created. As shown in FIG. 8, new block 830 is created and then added to blockchain 840. The new block of the ledger is then added to the blockchain, making it permanent and immutable. Once the new block of the ledger is added, user 2 receives the cryptographic digital asset.

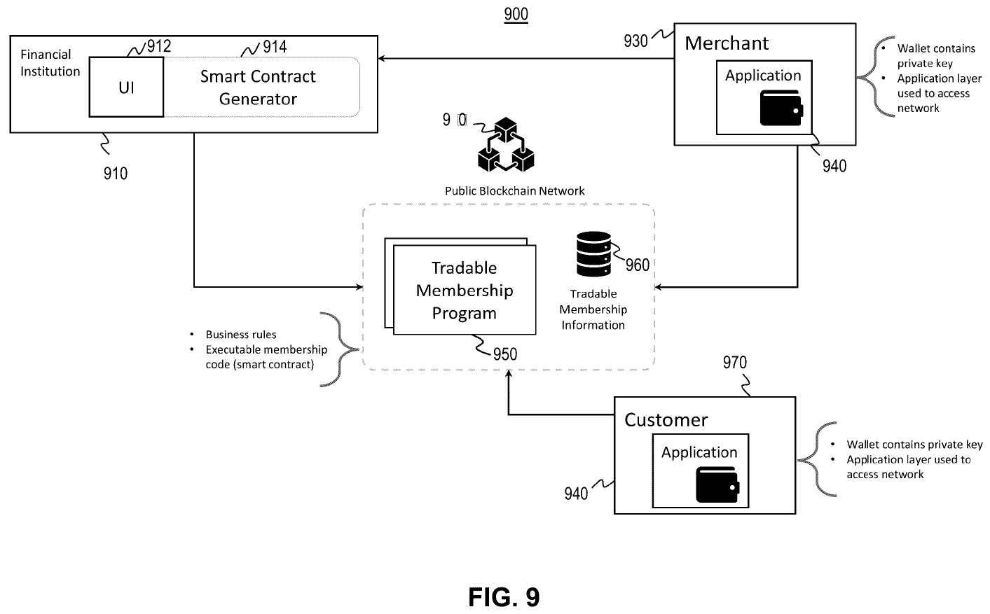

FIG. 9 illustrates an example embodiment 900 of a public blockchain that stores all information related to the management of user memberships, consistent with disclosed embodiments. As shown in FIG. 9, a financial institution 910 may have a user interface 912 and a smart contract generator 914 that may be used to communicate over a public blockchain network 920 with a tradeable membership program 950 using tradeable membership information 960 via a merchant 930 and a customer 970 using an application 940. A tradeable membership program may refer to a system that allows buyers and sellers to trade memberships that are issued by membership issuers on a secure platform. Tradeable membership information 960 may encompass all information related to the smart contracts, cryptographic digital assets, users, and any other participants in the tradeable membership program. Since all information is stored on the blockchain, memberships may be verified by checking ownership against the immutable blockchain ledger. For example, a membership issuer may keep a record of members and an associated wallet, such as wallet 520.

In some embodiments, financial institution 910 may be a bank or other institution capable of performing the disclosed embodiments. The user interface 912 may be similar to or different from the previously described user interfaces, and as shown in FIG. 9 may be associated with financial institution 910 for the purpose of generating a smart contract using smart contract generator 914, consistent with disclosed embodiments. The financial institution may communicate directly with a merchant, such as merchant 930. In some embodiments, a financial institution may employ an API call to deploy a smart contract. Merchant 930 may represent a seller or someone looking to trade a membership, consistent with disclosed embodiments. Merchant 930 may also represent a membership issuer, which may be an individual issuer or an entity issuer, and may submit a request to issue a membership, as described with respect to FIG. 6.

Merchant 930 may use an application 940, such as an application layer to access public blockchain network 920. In some embodiments, an API call may be used for a merchant to request membership information or to mint new membership tokens. Public blockchain network 920 may be any public blockchain, such as Ethereum, Solana, Bitcoin, or Ivno. A public blockchain network is one that anyone can view, send transactions to, and expect the transactions to be included in the blockchain if they are valid and participate in the consensus process, which determines which blocks are added to the blockchain. The consensus process may be a program used in a blockchain network to achieve agreement about the distributed ledger's state. In some embodiments, the public blockchain is anonymous. The public blockchain may be adopted by many organizations and entities and may not use third party verification.

In some embodiments, the blockchain may contain five layers: the hardware layer, the data layer, the network layer, the consensus layer, and the application layer. The hardware layer may comprise the physical components needed to operate the blockchain, such as computers, servers, and nodes. The data layer may comprise the information and transactional details related to blockchain transactions. The transaction information may be stored on a block and includes information about the public key, the private key, and recipient-specific information. For example, the data layer may be represented by tradeable membership information 960, which may contain the transactional information. The network layer may handle communication between blockchain nodes. The network layer may ensure that nodes can find one another and interact with each other. The nodes in the network layer may be distributed and share the workload. The consensus layer may validate each transaction using a consensus mechanism, such as proof of work to validate and add transactions to the blockchain. The application layer may include smart contracts and other software that runs on the blockchain network, as shown in FIG. 9, on both the merchant and customer ends. Application 940 may be used to access the network through the network layer.

The tradeable memberships program 950 describes the types of transactions that may occur on the blockchain network. For example, the program may contain business rules specific to a particular merchant or customer, and may use those rules to generate the smart contract. In some embodiments, the predefined business rules may require an association of a wallet with a user to track ownership, transfer functionality that allows a user to change ownership of a cryptographic digital asset, and a minting functionality to allow users to mint new NFTs. In some embodiments, all predefined business rules may be stored in the smart contract. In some embodiments, an API call may be used to allow a merchant to access the smart contract.

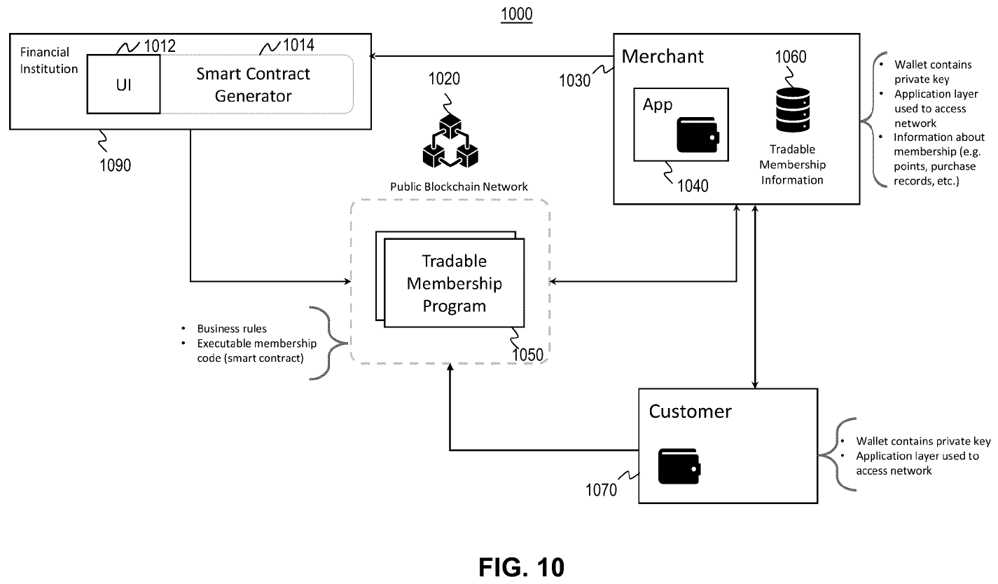

FIG. 10 illustrates an example embodiment 1000 of a public blockchain that stores some information related to the management of user memberships but not all information, consistent with disclosed embodiments. For example, the tradeable membership program may obtain information related to the tradeable memberships from a customer database, such as a database for a loyalty program. Tracking loyalty programs and managing rewards may be difficult given the number of people that may be part of the brand loyalty programs. For example, hundreds of thousands of people may be associated with an airline frequent flyer program. Providing digital assets associated with brand loyalty may provide an easier method for membership issuers, discussed with respect to FIG. 6 to track memberships associated with a brand loyalty program and may also allow users of the brand loyalty program to monetize their assets. As shown in FIG. 10, a financial institution 1090 may have a user interface 1012 and a smart contract generator 1014 that may be used to communicate over a public blockchain network 1020 with a tradeable membership program 1050 using tradeable membership information 1060 via a merchant 1030 and a customer 1070 using an application 1040. A membership issuer may decide to store certain information off the blockchain, at its discretion. A membership issuer may determine how to communicate this information to buyers and sellers separate from the blockchain. For example, a membership issuer may decide to store information related to loyalty programs off the blockchain.

In some embodiments, financial institution 1090 may be a bank or other institution capable of performing the disclosed embodiments. The user interface 1012 may be similar to or different from the previously describer user interfaces, and as shown in FIG. 10 may be associated with financial institution 1090 for the purpose of generating a smart contract using smart contract generator 1014, consistent with disclosed embodiments. The financial institution may communicate directly with a merchant, such as merchant 1030. Merchant 1030 may represent a seller or someone looking to trade a membership, consistent with disclosed embodiments. Merchant 1030 may also represent a membership issuer, which may be an individual issuer or an entity issuer, and may submit a request to issue a membership, as described with respect to FIG. 6. Merchant 1030 may also represent a merchant that has a loyalty program.

Merchant 1030 may use an application 1040, such as an application layer to access public blockchain network 1020. Public blockchain network 1020 may be any public blockchain, such as Ethereum, Solana, Bitcoin, or Ivno.

In some embodiments, the blockchain may contain five layers: the hardware layer, the data layer, the network layer, the consensus layer, and the application layer. For example, the data layer may be represented by tradeable membership information 1060, which may contain the transactional information. In some embodiments, tradeable membership information 1060 may be related to a particular merchant, such as merchant 1030. In some embodiments, tradeable membership information 1060 may be related to information about a loyalty program membership, such as points, purchase records, and rewards. The network layer may handle communication between blockchain nodes. The consensus layer may validate each transaction using a consensus mechanism, such as proof of work to validate and add transactions to the blockchain. The application layer may include smart contracts and other software that runs on the blockchain network, as shown in FIG. 10, on both the merchant and customer ends. Application 1040 may be used to access the network through the network layer. In some embodiments, a customer 1070 may check the value of membership properties stored by a merchant. In some embodiments, checking the value may be done using an API call.

The tradeable memberships program 1050 describes the types of transactions that may occur on the blockchain network. For example, the program may contain business rules specific to a particular merchant or customer, and may use those rules to generate the smart contract.

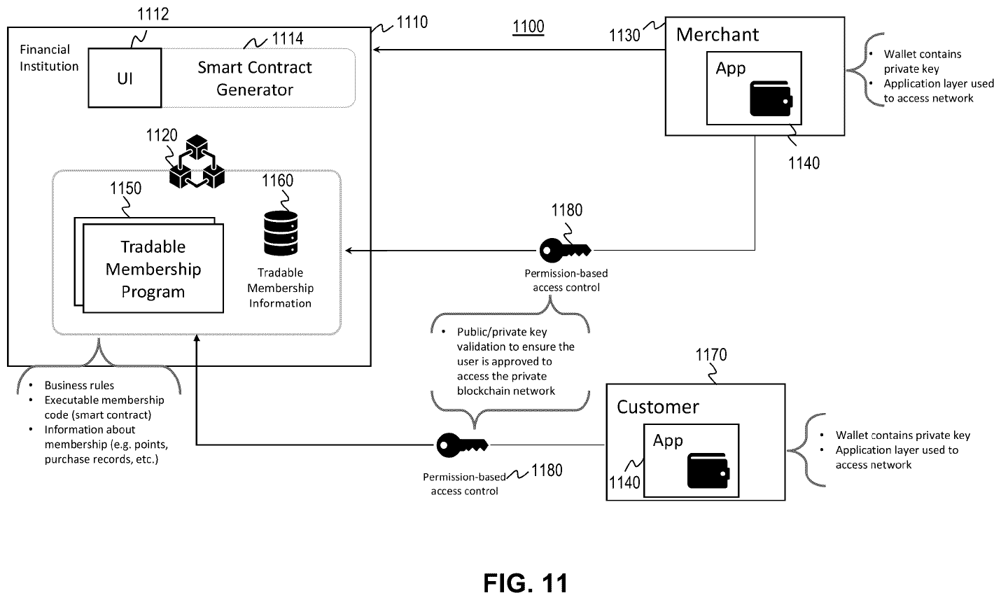

FIG. 11 illustrates an example embodiment 1100 of a private blockchain that stores all information related to the management of user memberships, consistent with disclosed embodiments. The tradeable membership program may obtain information related to the tradeable memberships from a customer database, such as a database for a loyalty program. As shown in FIG. 11, a financial institution 1110 may have a user interface 1112 and a smart contract generator 1114 that may be used to communicate over a private blockchain network 1120 with a tradeable membership program 1150 using tradeable membership information 1160 via a merchant 1130 and a customer 1170 using an application 1140. Access to the information and the private network may occur via a permission-based access control 1180. Since all information is stored on the blockchain, memberships may be verified by checking ownership against the immutable blockchain ledger.

The private blockchain may require credentials to view any information stored on the private blockchain. By contrast, information stored on the public blockchain may enable anyone to view transactions. The public blockchain may still keep private certain information related to transactions.

In some embodiments, financial institution 1110 may be a bank or other institution capable of performing the disclosed embodiments. The user interface 1112 may be similar to or different from the previously describer user interfaces, and as shown in FIG. 11 may be associated with financial institution 1110 for the purpose of generating a smart contract using smart contract generator 1114, consistent with disclosed embodiments. The financial institution may communicate directly with a merchant, such as merchant 1130. Merchant 1130 may represent a seller or someone looking to trade a membership, consistent with disclosed embodiments. Merchant 1130 may also represent a membership issuer, which may be an individual issuer or an entity issuer, and may submit a request to issue a membership, as described with respect to FIG. 6. Merchant 1130 may also represent a merchant that has a loyalty program.

Merchant 1130 may use an application 1140, such as an application layer to access private blockchain network 1120. A private blockchain may only allow selected and verified participants to operate on the blockchain. In some instances, the operator of the private blockchain may have the right to override, edit, or delete entries on the blockchain. In some embodiments, an invitation may be required to join the private blockchain. The invitation may comprise an authentication procedure to verify an identity before a user can operate on the blockchain. In this way, the private blockchain may control who can participate on the network and only select users can maintain the shared ledger. The private blockchain, unlike a public blockchain, as described with respect to FIGS. 9 and 10, is not decentralized and instead has a distributed ledger that operates using the cryptographic concepts described in this application. Permission based access control 1180 may be used to access the private blockchain, consistent with disclosed embodiments. For example, access may be based on using a key, as described with respect to FIG. 6.

In some embodiments, for example, the data layer may be represented by tradeable membership information 1160, which may contain the transactional information related to the smart contract. In some embodiments, tradeable membership information 1160 may be related to a particular merchant, such as merchant 1130. In some embodiments, tradeable membership information 1160 may be related to information about a loyalty program membership, such as points, purchase records, and rewards. The network layer may handle communication between blockchain nodes. The consensus layer validates each transaction using a consensus mechanism, such as proof of work to validate and add transactions to the blockchain. The application layer may include smart contracts and other software that runs on the blockchain network, as shown in FIG. 11, on both the merchant and customer ends. Application 1140 may be used to access the network through the network layer.

The tradeable memberships program 1150 describes the types of transactions that may occur on the blockchain network. For example, the program may contain business rules specific to a particular merchant or customer, and may use those rules to generate the smart contract.

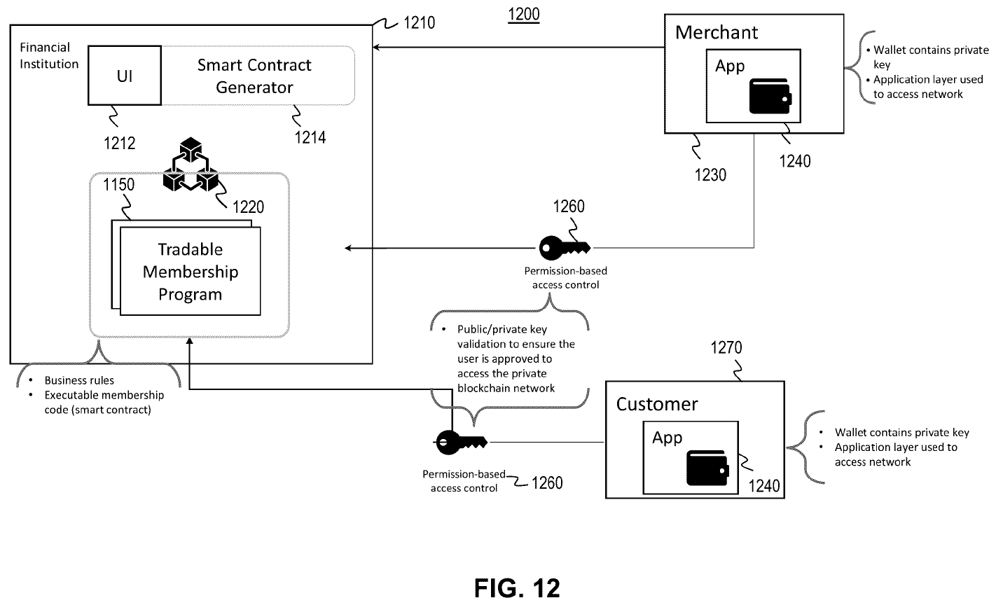

FIG. 12 illustrates an example embodiment of a private blockchain that stores some information related to the management of user memberships but not all information, consistent with disclosed embodiments. For example, the tradeable membership program may obtain information related to the tradeable memberships from a customer database, such as a database for a loyalty program. The tradeable membership program may obtain information related to the tradeable memberships from a customer database, such as a database for a loyalty program. As shown in FIG. 12, a financial institution 1210 may have a user interface 1212 and a smart contract generator 1214 that may be used to communicate over a private blockchain network 1220 with a tradeable membership program 1250 via a merchant 1230 and a customer 1270 using an application 1020. Access to the information and the private network may occur via a permission-based access control 1260. A membership issuer may decide to store certain information off the blockchain, at its discretion. A membership issuer may determine how to communicate this information to buyers and sellers separate from the blockchain. For example, a membership issuer may decide to store information related to loyalty programs off the blockchain.

In some embodiments, financial institution 1210 may be a bank or other institution capable of performing the disclosed embodiments. The user interface 1212 may be similar to or different from the previously describer user interfaces, and as shown in FIG. 12 may be associated with financial institution 1210 for the purpose of generating a smart contract using smart contract generator 1214, consistent with disclosed embodiments. The financial institution may communicate directly with a merchant, such as merchant 1230. Merchant 1230 may represent a seller or someone looking to trade a membership, consistent with disclosed embodiments. Merchant 1230 may also represent a membership issuer, which may be an individual issuer or an entity issuer, and may submit a request to issue a membership, as described with respect to FIG. 6. Merchant 1230 may also represent a merchant that has a loyalty program.

Merchant 1030 may use an application 1240, such as an application layer to access private blockchain network 1220. A private blockchain only allows selected and verified participants to operate on the blockchain. In some instances, the operator of the private blockchain may have the right to override, edit, or delete entries on the blockchain. In some embodiments, an invitation may be required to join the private blockchain. The invitation may comprise an authentication procedure to verify an identity before a user can operate on the blockchain. In this way, the private blockchain controls who can participate on the network and only select users can maintain the shared ledger. The private blockchain, unlike a public blockchain, as described with respect to FIGS. 9 and 10 is not decentralized and instead has a distributed ledger that operates using the cryptographic concepts described in this application. Permission based access control 1260 may be used to access the private blockchain, consistent with disclosed embodiments. For example, access may be based on using a key, as described with respect to FIG. 6.

In some embodiments, the blockchain contains five layers: the hardware layer, the data layer, the network layer, the consensus layer, and the application layer. The hardware layer comprises the physical components needed to operate the blockchain, such as computers, servers, and nodes. The data layer comprises the information and transactional details related to blockchain transactions. The transaction information is stored on a block and includes information about the public key, the private key, and recipient-specific information. The network layer may handle communication between blockchain nodes. The consensus layer validates each transaction using a consensus mechanism, such as proof of work to validate and add transactions to the blockchain. The application layer may include smart contracts and other software that runs on the blockchain network, as shown in FIG. 12, on both the merchant and customer ends. Application 1240 may be used to access the network through the network layer.

The tradeable memberships program 1250 may describe the types of transactions that may occur on the blockchain network. For example, the program may contain business rules specific to a particular merchant or customer, and may use those rules to generate the smart contract.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. Some steps may be deleted, added, or modified. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-20. (canceled)

21. A computer-implemented method executed by at least one processor, for management of user memberships using a software module, comprising:
authenticating a membership issuer using a graphical user interface;
issuing a membership to a user, over a distributed computing network on a server, to a user device associated with the user based on the authentication;
generating a cryptographic digital asset associated with the membership;
creating the software module including an agreement and one or more predetermined conditions, wherein the software module is programmed to automatically update ownership of the cryptographic digital asset upon completion of the one or more predetermined conditions;
associating the cryptographic digital asset with the user;
enforcing the agreement and the one or more predetermined conditions using the software module; and
sending for display to a user device, confirmation of the software module associated with the cryptographic digital asset.

22. The method of claim 21, wherein the software module is embedded with the one or more predetermined conditions to ensure compliance with a membership regulation.

23. The method of claim 22, wherein the membership regulation refers to at least one of a set of rules, a set of requirements, a set of regulations, or a set of qualifications associated with the membership issuer.

24. The method of claim 21, wherein the software module is associated with each individual transaction between users.

25. The method of claim 21, wherein the cryptographic digital asset is a non-fungible token (NFT).

26. The method of claim 21, wherein the software module is linked to a template associated with the user.

27. The method of claim 21, wherein the software module is self-executing.

28. The method of claim 21, wherein the software module is used to transfer ownership of the cryptographic digital asset from the user to another user.

29. The method of claim 21, wherein the software module authenticates ownership of the membership.

30. The method of claim 21, wherein the membership issuer can track membership ownerships on a distributed cryptographic digital asset private key generator.

31. A system for management of user memberships using a software module, comprising:
a memory storing instructions; and
at least one processor in electronic communication with the memory, the at least one processor configured to execute the instructions to:
authenticate a membership issuer using a graphical user interface;
issue a membership to a user, over a distributed computing network on a server, to a user device associated with the user based on the authentication;
generate a cryptographic digital asset associated with the membership;
create the software module including an agreement and one or more predetermined conditions, wherein the software module is programmed to automatically update ownership of the cryptographic digital asset upon completion of the one or more predetermined conditions;
associate the cryptographic digital asset with the user;
enforce the agreement and the one or more predetermined conditions using the software module; and
send for display to a user device, confirmation of the software module associated with the cryptographic digital asset.

32. The system of claim 31, wherein the software module is embedded with the one or more predetermined conditions to ensure compliance with a membership regulation.

33. The system of claim 32, wherein the membership regulation refers to at least one of a set of rules, a set of requirements, a set of regulations or a set of qualifications associated with the membership issuer.

34. The system of claim 31, wherein the software module is associated with each individual transaction between users.

35. The system of claim 31, wherein the cryptographic digital asset is a non-fungible token (NFT).

36. The system of claim 31, wherein the software module is linked to a template associated with the user.

37. The system of claim 31, wherein the software module is self-executing.

38. The system of claim 31, wherein the software module is used to transfer ownership of the cryptographic digital asset from the user to another user.

39. The system of claim 31, wherein the software module authenticates ownership of the membership.

40. The system of claim 31, wherein the membership issuer can track membership ownerships on a distributed cryptographic digital asset private key generator.
